(19) United States
(12) Patent Application Publication
(10) Pub. No.: US 2012/0268386 A1
(43) Pub. Date: Oct. 25, 2012

(54) TOUCH-SCREEN DEVICE INCLUDING TACTILE FEEDBACK ACTUATOR

(76) Inventors: James Robert KARAMATH, Abingdon (GB); Christopher Brown, Oxford (GB)

(21) Appl. No.: 13/089,389

(22) Filed: Apr. 19, 2011

(51) Int. Cl. G06F 3/041

(52) U.S. Cl. 345/173

(57) ABSTRACT

A touch-screen device includes a display; a tactile feedback actuator arranged on the display, including a first substrate, a second substrate facing the first substrate, the first substrate and the second substrate being parallel to each other in a lateral direction, and movable relative to each other in the lateral direction; and an electrode arrangement on the first substrate and the second substrate, whereby a potential difference applied across two or more electrodes in the electrode arrangement produces an electrostatic force in the lateral direction between the first substrate and the second substrate; and a controller configured to apply a time-varying potential difference across the two or more electrodes such that the resultant electrostatic force varies in the lateral direction and induces oscillatory lateral movement of the first substrate relative to the second substrate.

### TECHNICAL FIELD

The invention relates to a touch-screen device, and more specifically a touch-screen device including a tactile feedback actuator that can reproduce tactile sensations in response to user input. The invention further relates to a structure and control means to generate tactile sensations through oscillatory motions.

### BACKGROUND ART

With touch-screen and touch-display devices (collectively referred to herein as “touch-screen devices”) rapidly growing in popularity, one significant shortcoming over traditional methods of data-entry has quickly become evident. The lack of tactile sensations perceived by the user when pressing “virtual” buttons on the touch-screen—the feelings of button edges and depressing the button for example—necessitates extra concentration by the user, who must look at the screen to help judge that they have correctly entered the data. Real buttons and keys help divide the mental effort amongst the senses with the sense of touch helping to limit the workload on the visual sensory system. It has been shown that data entry using virtual buttons, as opposed to traditional physical buttons, causes an increase in data entry error rates and a decrease in user satisfaction due to the lack of such realistic tactile sensations.

It is well known that touch-screen devices may be enhanced through the addition of a means to artificially create tactile sensations, a feature known as tactile feedback. For example, when the user touches the touch-screen in a location corresponding to that of a virtual button the tactile feedback device stimulates the user's finger to artificially re-create the sensation of touching a physical button.

One method of creating tactile sensations is described in WO2008/037275 (P. Laitinen; pub. Apr. 3, 2008) where actuators are formed by pressurised fluids in combination with a deformable surface. However, pressurized fluid devices are not transparent enough for addition to a touch-screen display and the deformable surface is not robust to wear and tear.

Another well-known method to reproduce tactile sensations is to stimulate one's sense of touch through vibrations, or oscillatory motions, of the surface of the device in contact with the user's finger. The generated vibrations may be in a direction normal to the plane of the surface (herein normal motion) or in a direction along the plane of the touch-screen (lateral motion). Since the skin is essentially insensitive to the direction of the vibrating motion either direction of motion is effective in reproducing tactile sensations.

There are a number of ways to generate each type of motion. For example, electro-active materials (those that change shape upon application of voltage) can be used as actuators to generate motion in a touch-screen device. US2008116764 (J. Heim; pub. May 22, 2008) describes such a device in which lateral motions are generated by electro-active polymer (EAP) actuators. In such a device the EAP is attached to the touch-screen and a high voltage is applied across the EAP causing it to contract. Contractions in the EAP are then transmitted to the touch-screen causing the device surface to move. However, since the EAP actuators are non-transparent they must be attached to the rear of the touch-screen and undesirably must therefore generate motion of the entire device. In addition, electro-active polymers generate relatively low forces and require complex pre-stretching techniques, compliant electrodes and high driving voltages to generate motion.

As disclosed in US20080062145 (E. Shahoian et al.; pub. Mar. 13, 2008) the electro-active material may be formed instead by piezo-electric ceramic devices. However, such devices have the disadvantage that they are fragile and expensive to produce.

Micro electro-mechanical switches (MEMS), as described in US20090002328 (C. Ullrich; pub. Jan. 1, 2009) are another known method of generating oscillatory motions. However, such MEMS devices are too fragile to sit on top of a touch-screen display and require a flexible top-surface to the display rendering it vulnerable to wear and tear.

WO2010080917 (C. Peterson et al., pub Jul. 15, 2010) describes a means of generating oscillatory motion through electrostatic actuation. In this device, shown in FIG. 1, electrostatic forces are used to drive opposing plates to mutually repel and attract causing motion normal to the surface of the device. The parallel plate electrodes in an electrostatic actuator 10 are separated by an air-gap 12 and a high dielectric constant material 13 is used firstly as insulation and secondly to increase the electrostatic forces generated. Motion is generated by charges being applied to the electrodes 11 and 14 wherein like charges cause repulsion of the plates and dissimilar charges cause attraction. Elastic spacers 17 are used to return the upper electrode 11 to an equilibrium position. The charges are provided by a high voltage signal generator (not shown) arranged to supply driving waveforms in a defined frequency range, typically 0-3000 Hz. The generated surface vibrations (represented by solid arrow) are normal to the plane of the touch panel 02 and perceived by the user 01 as tactile sensations. This arrangement can be transparent and placed on top of a display 03 (e.g. liquid crystal display (LCD), electronic (e)-paper, organic light emitting diode (OLED), etc). The main advantage of this method (herein “electrostatics method”) is its simplicity: oscillatory motions are generated simply by varying a potential difference between the plates of the capacitor. A main disadvantage of this method however is that the generated tactile sensations require large amplitude of normal motion and this must be accounted for in the design of the touch-screen module resulting in an increase in the thickness of the device. In addition, the motion of the surface in this way can produce audible noise which may be a source of undesirable distraction for the user.

### SUMMARY OF INVENTION

An apparatus for producing tactile feedback in a touch-screen device is disclosed. As described above, lateral motion or movement is the preferred method for generating oscillatory motions in touch-feedback devices due to space and noise requirements. The “electrostatics method” is preferred due to its simplicity of construction and operation.

The touch-screen device discussed herein incorporates a tactile feedback actuator which includes: a first substrate, the top surface of which is touched by the user and the bottom surface of which forms a first structure to generate oscillatory lateral movement; and a second substrate the top surface of which forms a second complementary structure to the bottom surface of the first substrate. Patterned electrodes are formed on both the first and second substrates and groups of the electrodes are electrically connected to form electrode sets. The sets of electrodes are arranged in pairs with one set of the pair formed on the first substrate and the other set formed on the second substrate. Electrical signals are applied to the electrode sets in such a way that an electrical potential difference between the electrode sets forming a pair is varied with respect to time. This potential difference generates an electrostatic force between the first substrate and second substrate causing the first substrate to move in a lateral direction relative to the second substrate. The magnitude of the potential difference may be controlled to vary the generated electrostatic force and the sign of the potential difference may be controlled to determine the direction of lateral motion. The lateral motion helps limit unwanted audible noise whilst the electrostatics method allows for a simple actuation. As will be described, this one-dimensional lateral motion is generated by a novel electrode design. Further, more complicated motions to reproduce more sophisticated touch sensations are made possible through variations in electrode design and driving methods.

According to an aspect of the invention, a touch-screen device includes a display; a tactile feedback actuator arranged on the display, including a first substrate, a second substrate facing the first substrate, the first substrate and the second substrate being parallel to each other in a lateral direction, and movable relative to each other in the lateral direction; and an electrode arrangement on the first substrate and the second substrate, whereby a potential difference applied across two or more electrodes in the electrode arrangement produces an electrostatic force in the lateral direction between the first substrate and the second substrate; and a controller configured to apply a time-varying potential difference across the two or more electrodes such that the resultant electrostatic force varies in the lateral direction and induces oscillatory lateral movement of the first substrate relative to the second substrate.

According to another aspect, the oscillatory lateral movement is within a frequency range of 0 to 30 kHz.

According to another aspect, the oscillatory lateral movement is within a frequency range of 200 Hz to 300 Hz.

In accordance with another aspect, the touch-screen device includes one or more elastic spacers for returning the first substrate to an equilibrium position relative to the second substrate following lateral motion due to the electrostatic force created by the time-varying potential difference so as to result in the oscillatory lateral movement.

In accordance with still another aspect, the touch-screen device includes an elastic seal for returning the first substrate to an equilibrium position relative to the second substrate following lateral motion due to the electrostatic force created by the time-varying potential difference so as to result in the oscillatory lateral movement.

According to another aspect, the controller applies the time-varying potential difference using driving voltages which are any one or more of a square wave, pulse, saw-tooth or sinusoidal waveform.

According to yet another aspect, the tactile feedback actuator is positioned above the display, and the first and second substrates and electrode arrangement are constructed of transparent material.

In accordance with another aspect, the tactile feedback actuator is positioned below the display, and the first and second substrates are constructed at least in part of non-transparent material.

According to yet another aspect, the first substrate includes a plurality of first ridges formed on a bottom of the first substrate; the second substrate includes a plurality of second ridges formed on a top of the second substrate, the second ridges being interdigitated with the first ridges; and the electrode arrangement includes one or more first electrodes on respective side walls of the first ridges, and one or more second electrodes on respective side walls of the second ridges.

In yet another aspect, a gap is provided between adjacent first and second ridges to allow oscillatory lateral movement between the first and second substrates to an extent detectable by touch.

In still another aspect, the first electrodes are combined into a plurality of first electrode sets, the second electrodes are combined into a plurality of second electrode sets, the first and second electrode sets are arranged into pairs wherein each pair includes a corresponding one of the plurality of first electrode sets and one of the plurality of second electrode sets, and the controller is configured to generate movement in one lateral direction by providing driving voltages to each of the first and second electrode sets.

With yet another aspect, the controller generates oscillatory lateral motion by alternately providing driving voltages to a first pair to generate movement in a first lateral direction and to a second pair to generate movement in second lateral direction opposite to the first lateral direction.

In still another aspect, the driving voltage applied to the first electrode set of a pair is of equal magnitude but opposite sign to the driving voltage applied to the second electrode set of the pair so that a potential difference is generated between the first and second electrode sets forming the pair to generate movement in a lateral direction.

According to another aspect, the controller maintains the potential of one electrode set of a pair at a constant value and applies a voltage pulse to the other electrode set of the pair so that a potential difference is generated between the electrode sets forming the pair to generate movement in a lateral direction.

In accordance with another aspect, the controller comprises a voltage power supply and a plurality of switches for providing the driving voltages to the first and second electrode sets.

According to another aspect, the touch-screen device further includes a dielectric spacer between electrodes on the side walls of adjacent interdigitated first and second ridges.

In accordance with another aspect, electrodes on the sidewalls of adjacent interdigitated first and second ridges are capable of contacting one another.

According to still another aspect, the controller monitors current provided to the first and second electrodes and varies the potential difference based on the current.

According to still another aspect, the first ridges face different directions over different regions of the bottom of the first substrate and the second ridges face correspondingly different directions over different regions of the top of the second substrate.

In still another aspect, the first and second ridges are arranged to allow motion in orthogonal lateral directions.

According to still another aspect, the first and second ridges are arranged in circular patterns.

With still another aspect, the first and second ridges have cross-sections which are at least one of rectangular, triangular, hemispherical, semi-oval or trapezoidal.

In another aspect, the controller is configured to detect a normal component of a force applied to a surface of the tactile feedback actuator by touch of a user.

In accordance with still another aspect, the controller includes a capacitance measuring system for measuring a capacitance between adjacent first and second electrodes in order to detect the normal component of the applied force.

According to another aspect, the first and second ridges have triangular cross-sections.

In yet another aspect, at least some of the first ridges and/or second ridges include electrodes on their peaks which oppose other electrodes on the opposite substrate, and the controller comprises circuitry to measure a capacitance between the peak electrodes and the opposing other electrodes.

With still another aspect, a fluid-filled gap is provided between adjacent first and second ridges.

According to another aspect, the fluid in the fluid-filled gap is an index matching fluid.

In still another aspect, the first substrate is physically divided into small sections, each with its own, independently addressed set of first electrodes.

### BRIEF DESCRIPTION OF DRAWINGS

FIG. 1 shows a conventional touch-screen device in which electrostatic forces are used to “actuate” the device normal to its surface.

FIG. 2 shows a first and basic embodiment of the present invention being used, for example, in a mobile device.

FIG. 3 shows a partially exploded and perspective view of the present invention according to the embodiment of FIG. 2, highlighting the ridges and electrodes and the first and second substrates.

FIGS. 4A and 4B show the invention according to the embodiment of FIG. 2 presented from the side highlighting the insulating layers and air gaps. FIG. 4A shows the positioning and labelling of the electrodes relative to the first and second substrates. FIG. 4B illustrates the definitions of electrode sets and electrode pairs to be related to how the invention will be driven.

FIGS. 5A and 5B show the motion due to altering the electrical potential of the electrodes. FIG. 5A shows one voltage state resulting in a certain physical state—“State 1”. FIG. 5B shows another voltage state resulting in a different physical state—“State 2”.

FIG. 6 shows the voltage waveforms on the electrode sets in the states shown in FIGS. 5A and 5B.

FIG. 7 shows the voltage waveforms on the electrode sets according to a second embodiment of the invention.

FIGS. 8A and 8B show an electrical diagram according to a third embodiment of the invention. FIG. 8A shows the electrical arrangement. FIG. 8B shows the voltage pulses provided by the supply and the phases of the two switches.

FIGS. 9A and 9B show the use of an elastic spacer to provide the return force for the actuation as discussed in the fourth embodiment. In FIG. 9A discrete spacers are shown as well as the action of one being compressed to store elastic potential energy. In FIG. 9B an elastic seal which performs the same task but provides a seal is shown.

FIG. 10 shows the voltage waveform used in accordance with a sixth embodiment of the invention, and the resulting positions of the substrates, the capacitances between electrode pairs and resulting current which is used to change the voltage states.

FIGS. 11A, 11B and 11C show a variety of other ridge patterns that can be used to generate motion in both the x and plane as discussed in accordance with an eighth embodiment of the invention.

FIG. 12 shows the present invention modified to detect force as described in accordance with a tenth embodiment.

FIG. 13 shows an electrode pair (capacitor) as used in accordance with the tenth to twelfth embodiments of the invention, connected to a capacitance measuring circuit used to measure the force on the first substrate.

FIG. 14 shows the present invention modified to detect force as described in accordance with an eleventh embodiment.

FIG. 15 shows the present invention modified to detect force as described in accordance with a twelfth embodiment.

FIG. 16 shows the tactile feedback actuator placed beneath the touch-screen display as discussed in accordance with a fourteenth embodiment.

FIG. 17 shows a flow diagram of how the invention would be used in a typical mobile device.

FIG. 18 shows a block diagram of how the component systems of the present invention interact in a typical mobile device.

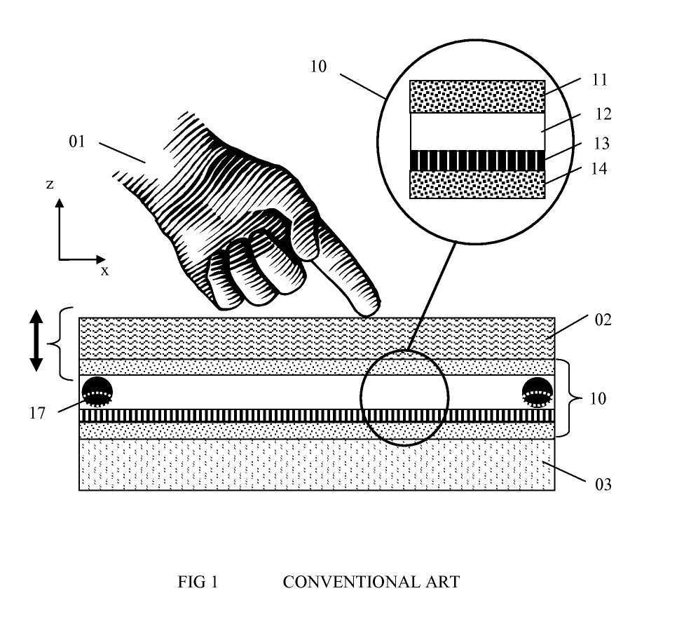

In the annexed drawings, like references indicate like parts or features.

### DESCRIPTION OF REFERENCE NUMERALS

01 user

02 touch panel

03 display, e.g. LCD, e-paper etc.

04 mobile device

10 electrostatic actuator

11 upper electrode

12 air gap

13 thin insulator with high dielectric strength and permittivity

14 lower electrode

17 elastically deformable spacers

20 tactile feedback actuator

21 first substrate

22 second substrate

23a ridges of first substrate

23b ridges of second substrate

24a first electrodes (coated on side walls of ridges of first substrate only)

24b second electrodes (coated on side walls of ridges of second substrate only)

25 insulating layers (preventing electrode touch)

26 spacing/air gap

35 pair of electrode sets

35a first pair of electrode sets

35b second pair of electrode sets

41 electrode set (member of second plurality of electrode sets)

42 electrode set (member of first plurality of electrode sets)

43 electrode set (member of second plurality of electrode sets)

44 electrode set (member of first plurality of electrode sets)

45 power (voltage) supplies

51 switch 1

52 switch 2

55 elastic spacers

56 frame

57 elastic seal

58 capacitance to frequency conversion circuit

59 frequency to digital conversion circuit

60 force calculation unit

61 CPU

62 display controller

65 touch panel controller

66 tactile feedback controller

68 memory

### DETAILED DESCRIPTION OF INVENTION

Tactile feedback may be generated in a number of ways, for example by physical motion of the skin or by electrical stimulation of the nerves in the skin. Of the former, the motion imposed on the skin can take various forms including normal indentation of the skin or lateral and shear movement of the skin. The sensation felt is essentially independent of which of these motions are used. To reproduce realistic tactile sensations the movement is usually in the form of oscillatory motion, or vibrations, at frequencies between 0 and 30 kHz. The vibration frequency range of 20 Hz-1 kHz is known to be most effective in reproducing realistic tactile sensations and, in particular, approximately 200-300 Hz corresponds to the frequency at which motion receptors in the skin are most sensitive. The oscillatory motion may be characterized by its amplitude, phase, force, waveform, cycle duration and number of cycles any of which may be controlled to generate a tactile sensation amounting to a perceived tactile effect. For example, tactile effects such as key edges, button clicks, bumps and pits can be simulated by a vibrating flat surface through control of these parameters.

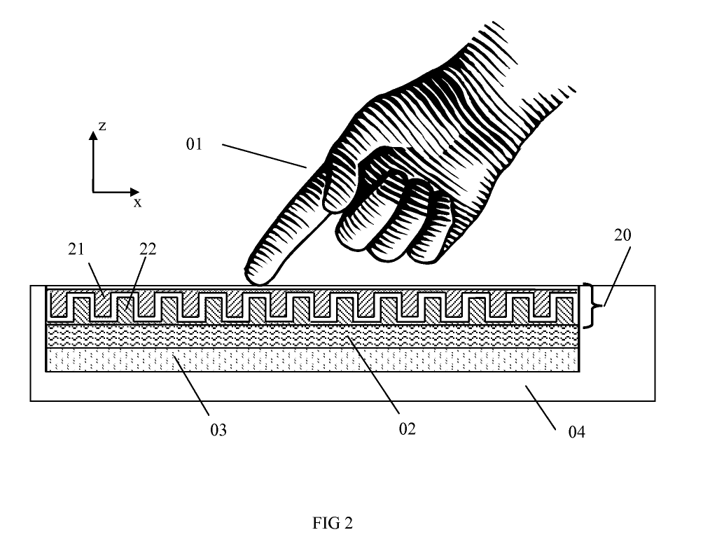

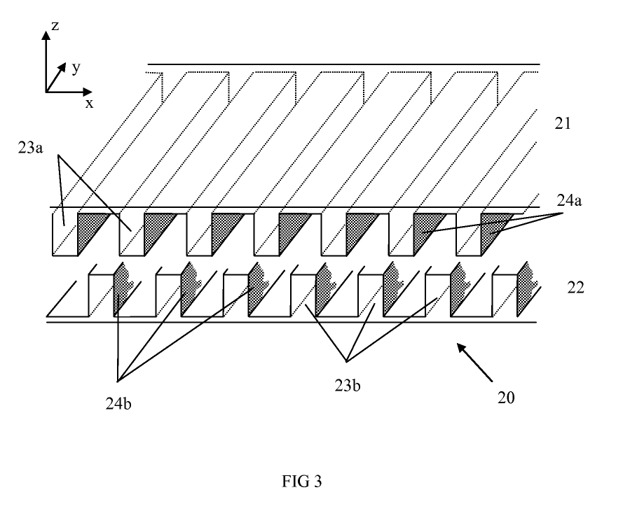

A first and most basic embodiment of the present invention is shown in FIG. 2 and FIG. 3. The tactile feedback actuator 20 in accordance with the present invention includes a first substrate 21, the top surface of which is touched by the user 01 and the bottom surface of which forms a first structure to generate oscillatory lateral motions; and a second substrate 22, movable relative to the first substrate, the top surface of which forms a second, complementary structure to the bottom surface of the first substrate 21. The substrate material for each of the first and second substrates can be made from a transparent material such as plastic or glass materials common in liquid crystal display manufacturing. The invention may find application in a mobile device 04 such as, but not limited to a PDA, Satellite Navigation, mobile phone, net-book, tablet, e-reader or the like.

Alternatively, the invention may find equal application in non-mobile devices such as workstation displays, etc. In any such devices the tactile feedback actuator 20 could be positioned above the touch-panel 02 and display (e.g. LCD, e-paper, OLED etc) 03 layers.

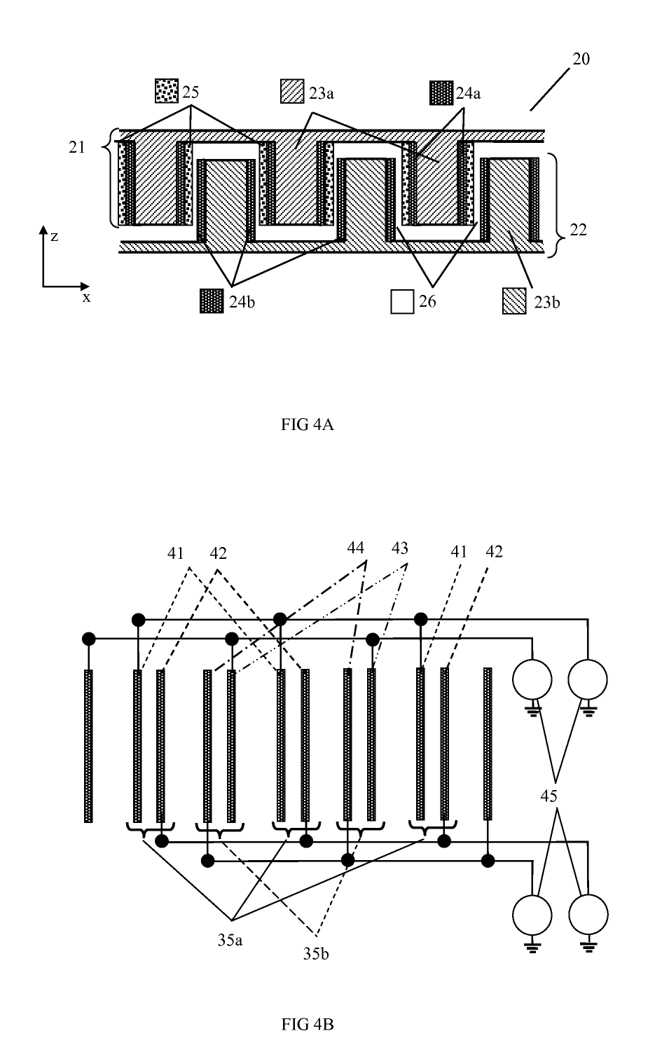

The detailed structure of the tactile feedback actuator 20 according to the first embodiment is shown in FIG. 3 and FIG. 4A. A plurality of first ridges 23a are formed on the bottom of the first substrate 21 and a plurality of complementary second ridges 23b are formed on the top of the second substrate 22. The ridges 23a,23b may be formed, for example by plasma etching a suitably masked sheet of organic polymer or glass or other transparent material serving as a substrate as described in Plasma Deposition, Treatment, and Etching of Polymers (ed. Riccardo d'Agostino) chapter 5 and is known in the science of liquid crystal display manufacturing. The reader will be aware that there are other methods by which ridges can be formed, for example, by simple milling of the surface, or by chemical etching. Alternatively the ridges can be built up on a planar surface.

The tactile feedback actuator 20 includes an electrode arrangement formed on the first and second substrates. More particularly, one or both side walls of the first ridges 23a are coated in a conductive material and patterned to form a plurality of first electrodes 24a. In addition, one or both side walls of the second ridges 23b are similarly coated in a conductive material and patterned to form a plurality of second electrodes 24b. The electrodes 24a and 24b can be made from a transparent conductor such as, but not limited to indium tin oxide (ITO). These can be deposited on the side walls of the ridges by directional vacuum deposition, directional thermal evaporation, etc., as is standard in the art.

FIG. 4A is a structural diagram showing an electrically insulating layer 25 separating adjacent electrodes 24a and 24b. The insulating layer 25 can be made of a transparent material, with a high dielectric strength and high relative permittivity; many plastics and ceramics could fulfill this role. The insulating layer 25 can be deposited (evaporation, spin/dip coating etc) on the ridged surface of the first substrate 21 and/or second substrate 22. For example, in the embodiment of FIG. 4A the insulating layer 25 is deposited on the ridged surface of the first substrate 21. However, it will be appreciated that the insulating layer 25 may additionally or alternatively be deposited on the ridged surface of the second substrate 22. The insulating layer 25 may also cover the tops of the ridges, depending on how it is deposited. Finally there is the extra “air-gap” or alternative type spacing 26 required to allow lateral movement between the first and second substrates 21 and 22 to an extent detectable by touch. For example, the spacing 26 may be on the order of 0.1 millimeters to 1 millimeters.

As described herein, the ridges 23a and 23b are complementary in structure in that the ridges are interdigitated. Consequently, the electrodes on the side walls of adjacent ridges will be offset laterally from one another. By applying a potential difference, i.e., voltage, across electrodes formed on adjacent side walls of one or more pairs of adjacent ridges, it is possible to produce a force of electrostatic attraction between the two substrates in the lateral direction. Similarly, by applying a time-varying potential difference across the electrodes an electrostatic force results between the two substrates which varies in the lateral direction and induces oscillatory lateral movement of the first substrate relative to the second substrate as described in more detail below.

FIG. 4B is an electrical diagram, illustrating the arrangement of electrodes into electrode sets and pairs as now described. The first electrodes 24a are combined with each other in groups of one or more to form a plurality of first electrode sets, e.g. sets 42 and 44. The second electrodes 24b are also combined with each other in groups of one or more to form a plurality of second electrode sets, e.g. sets 41 and 43. Each of the first and second electrode sets are connected to corresponding external signal source(s) 45 which may be used to apply a unique driving signal to each set. The sets of electrodes are further arranged into pairs 35a and 35b wherein a pair comprises one electrode set from the plurality of first electrode sets (e.g., 42 and 44) and one electrode set from the plurality of second electrode sets (e.g., 41 and 43). For example, a first pair 35a comprises electrode sets 41 and 42 and a second pair 35b comprises electrode sets 43 and 44. When voltage is applied to the electrode sets, electrostatic forces between the pairs will cause relative motion between the first and second substrates 21,22 as will be described shortly.

As shown in FIGS. 3 and 4A-4B, the first and second substrates 21,22 are arranged in opposition to each other such that the first and second electrode sets forming a pair are physically located opposite each other, separated in the lateral direction (i.e., in a direction parallel to the first and second substrates 21,22) by only the dielectric layers 25 and air gaps 26.

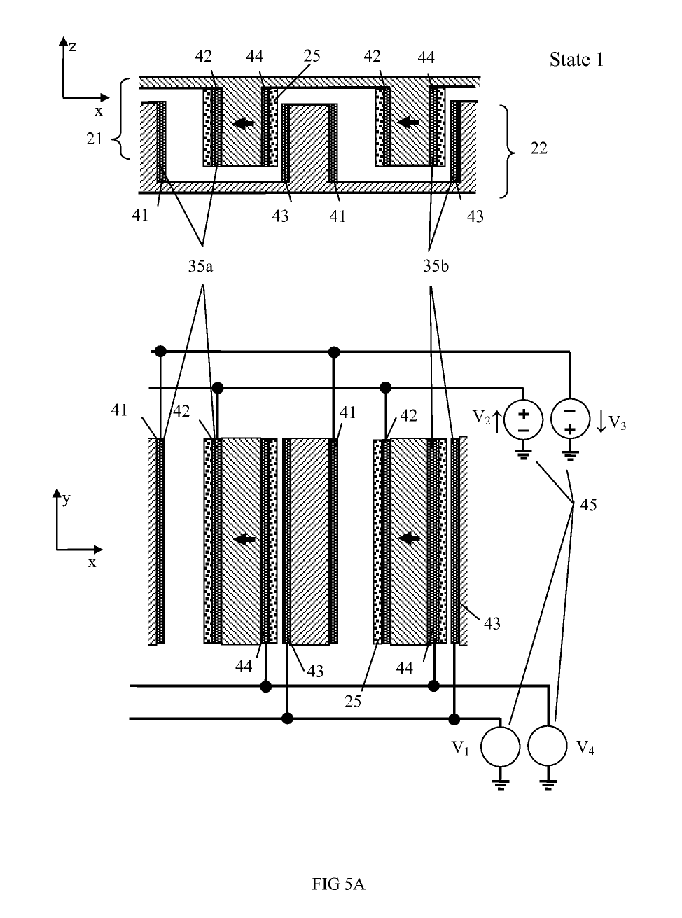

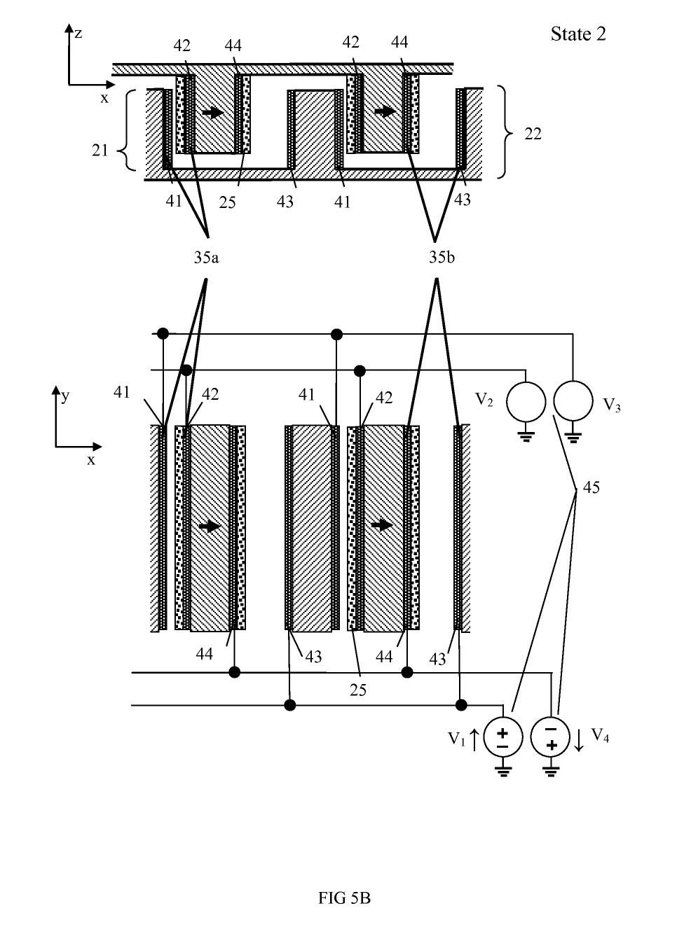

The operation of this structure to create tactile sensations is now described. FIG. 5A illustrates an example of how the electrodes may be addressed to generate lateral electrostatic forces between the respective substrates. As shown, a first electrode set 42 and a second electrode set 44 are members of the plurality of first electrode sets, which are formed on the ridge walls of the first substrate 21. A third electrode set 41 and a fourth electrode set 43 are members of the plurality of second electrode sets, which are formed on the ridge walls of the second substrate 22. The first electrode set 42 and the third electrode set 41 form a first pair 35a. The second electrode set 44 and the fourth electrode set 43 form a second pair 35b. Electrical connections are made from these four electrode sets to the four power supplies 45. The voltages of these supplies are varied as now described.

In a first state of operation, herein “State 1”, the voltage V₂ on the first electrode set 42, is driven to a positive potential, and the voltage V₃ on the third electrode set 41, is driven to a negative potential. The voltage V₄ on the second electrode set 44, and the voltage V₁ on the fourth electrode set 43, are driven to equal potentials, such as the system ground potential. An electrostatic force of attraction is now created between the electrode sets 41,42 forming the first pair 35a due to the difference in electrical potential (V₂−V₃) and this causes the first substrate 21 to move relative to the second substrate 22 in a negative direction relative to the x-axis as indicated by the arrows in FIG. 5A.

In a second state of operation, herein “State 2”, the voltage V₄ on the second electrode set 44 is driven to a positive potential, and the voltage V₁ on the fourth electrode set 43 is driven to a negative potential. The voltage V₂ on the first electrode set 42 and the voltage V₃ on the third electrode set 41 are driven to the same potential, such as the system ground potential. An electrostatic force of attraction is now created between the electrode sets 43,44 forming the second pair 35b due to the difference in electrical potential (V₄−V₁) and this causes the first substrate 21 to move relative to the second substrate 22 in a positive direction relative to the x-axis, as indicated by the arrows on FIG. 5B.

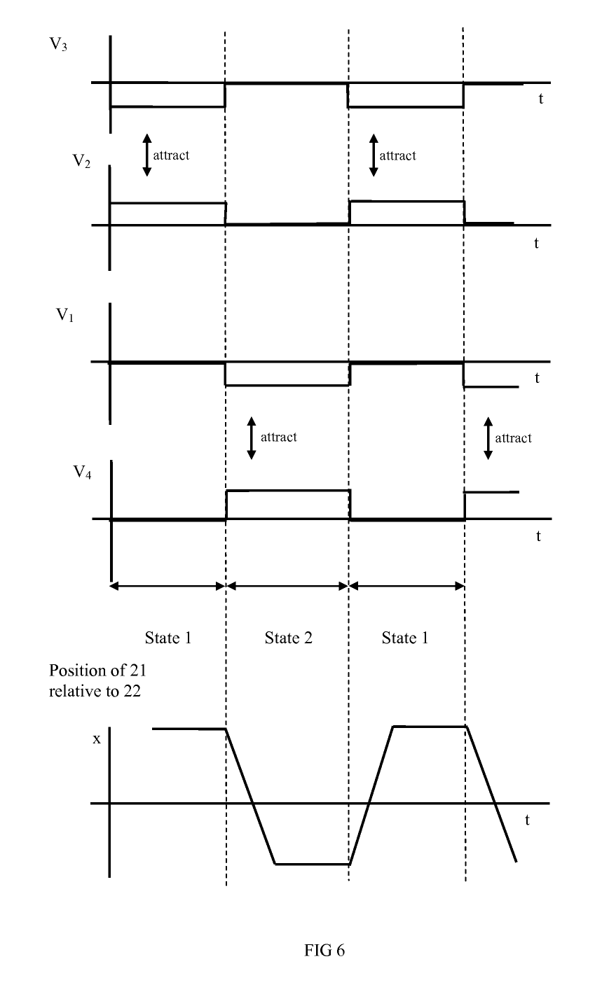

By alternately applying the driving waveforms of the first and second states the first substrate 21 is caused to oscillate back and forth relative to the second substrate 22 in a lateral motion along the x-axis. Further, since the second substrate 22 is typically anchored and immobile relative to the device in which it is implemented, the first substrate 21 is caused to move relative to the user's finger and the vibrations are detected by the user 01 as tactile sensations as previously described. FIG. 6 shows graphs of the voltages waveforms used in this embodiment to produce the time-varying potential difference across the respective electrode sets and an approximation of the resultant motion of the first substrate 21 relative to the second substrate 22.

The reader will be aware of the symmetry of the system. In alternative arrangements the motion is laterally along the y-axis, or the second substrate 22 can be moved relative to a fixed first substrate 21 if desired. The polarities of the power supplies can be the reverse of those shown. There is also no restriction on the type of waveform used to create the motion.

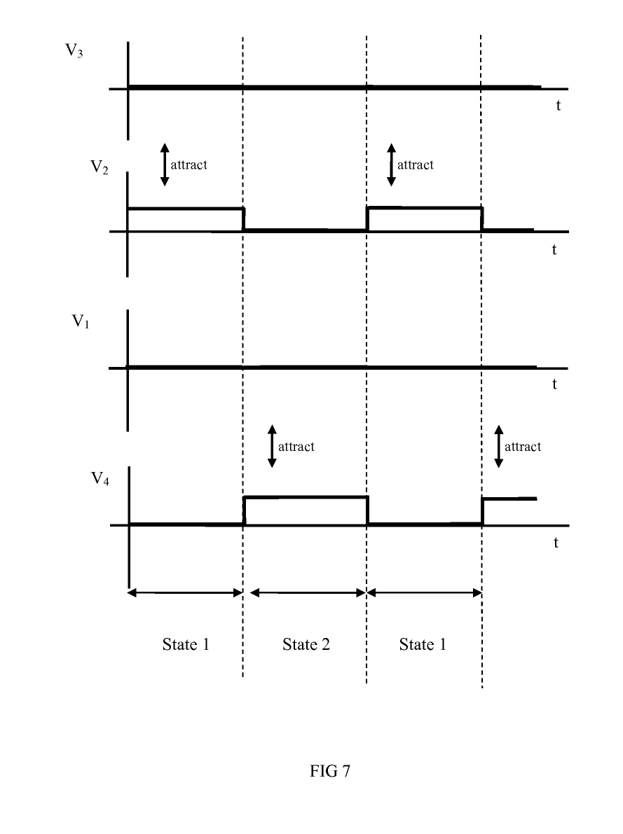

In a second embodiment of this invention, a pulse of either positive or negative potential is applied to one electrode set (e.g. 42) of a first pair 35a to generate the time-varying potential difference across the respective electrode sets and resultant electrostatic force of attraction between the two electrode sets forming the pair. (In other words, one electrode set of the first pair 35a receives a voltage pulse whilst the other electrode set of the first pair 35a remains at a fixed potential such as the system ground.) The return motion is generated by repeating this operation on one electrode set (e.g. 43) of the other electrode pair 35b. (In other words, one electrode set of the second pair 35b receives a voltage pulse whilst the other electrode set of the second pair remains at a fixed potential such as the system ground). This is shown in FIG. 7. In State 1, V₃ is at ground potential and V₂ has a potential pulse applied to it (V₁ and V₄ are both at ground potential). This causes attraction between the electrode sets 41 and 42 of the first pair 35a and generates motion of the first substrate 21 relative to the fixed second substrate 22. In State 2, V₂ and V₃ are now both at ground potential and thus there is no force between electrode sets 41 and 42 of the first pairs 35a. However, V₄ now has a potential pulse applied to it whilst V₁ is at ground potential and there is therefore an attractive force between electrode sets 43 and 44 of the second pair 35b. This generates motion of the first substrate 21 relative to the second fixed substrate 22 in the opposite direction to the motion generated in State 1. Continuing to repeat this operation causes the first substrate 21 to vibrate, relative to the second substrate 22, providing tactile sensations that can be detected by the user 01. Again, the reader will be aware of the symmetry in the system. Note that, in this embodiment just two power supplies are required—V₁ and V₃ can be permanently connected to the ground potential.

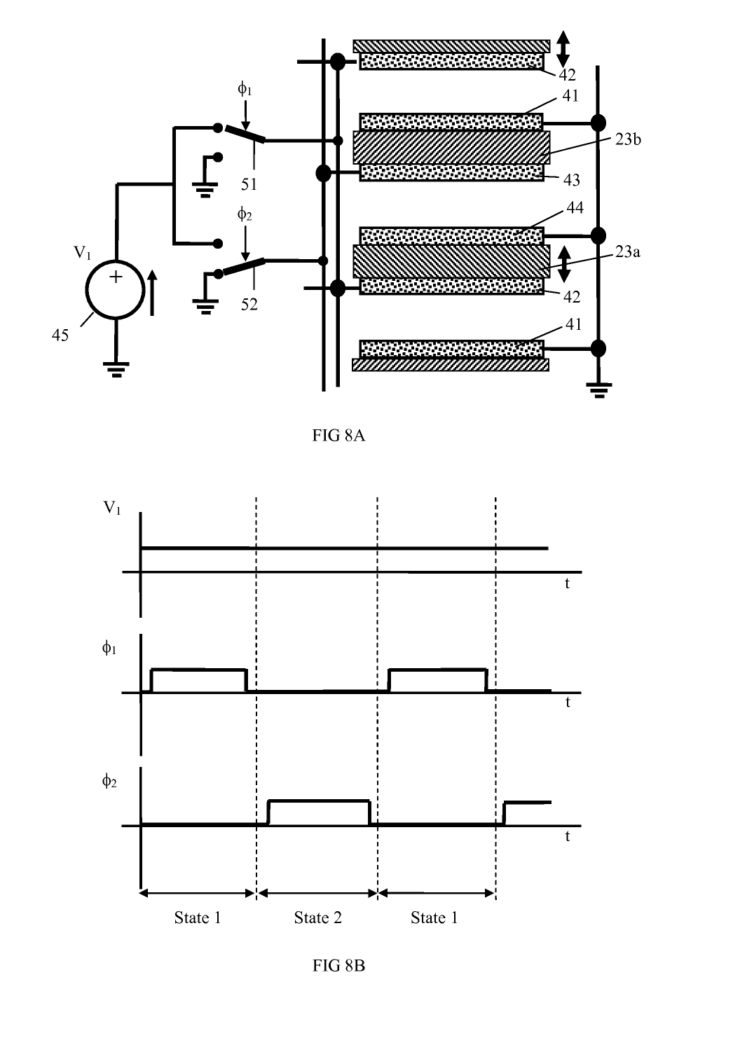

In a third embodiment of this invention, an alternative arrangement of the second embodiment, just one power supply is required; electrode sets 41 and 44 are connected to the ground potential, whilst the output from one power supply 45 is selectively applied to electrode sets 42 and 43. The distribution of the power supply potential to the electrode sets 42 and 43 is controlled by a pair of switches, wherein a first switch 51 is controlled by a first timing signal, Φ₁, and a second switch 52 is controlled by a second timing signal Φ₂. This arrangement is shown in FIG. 8A. An example of the power supply voltage and switch control signals, Φ₁ and Φ₂, used to create the tactile sensation are shown in FIG. 8B. In State 1 (represented in FIG. 8B), the first switch 51 is connected to the power supply 45 whilst the second switch 52 is connected to the ground potential. This causes an attractive force between electrode sets 41 and 42 of the first pair 35a and generates motion of the first substrate 21 relative to the fixed second substrate 22. In State 2, the first switch 51 is connected to the ground potential and the second switch 52 is connected to the power supply 45 such that the electrode set 43 reaches the potential V₁. This causes an attractive force between electrode sets 43 and 44 of the second pair 35b and generates motion of the first substrate 21 relative to the fixed second substrate 22 in the opposite direction to State 1. Continuing to repeat this operation causes the first substrate 21 to vibrate relative to the second substrate 22 and provides tactile sensations that can be detected by the user 01. The reader will be aware that other switch and power supply arrangements are possible, for example, a power supply 45 of negative potential could be used.

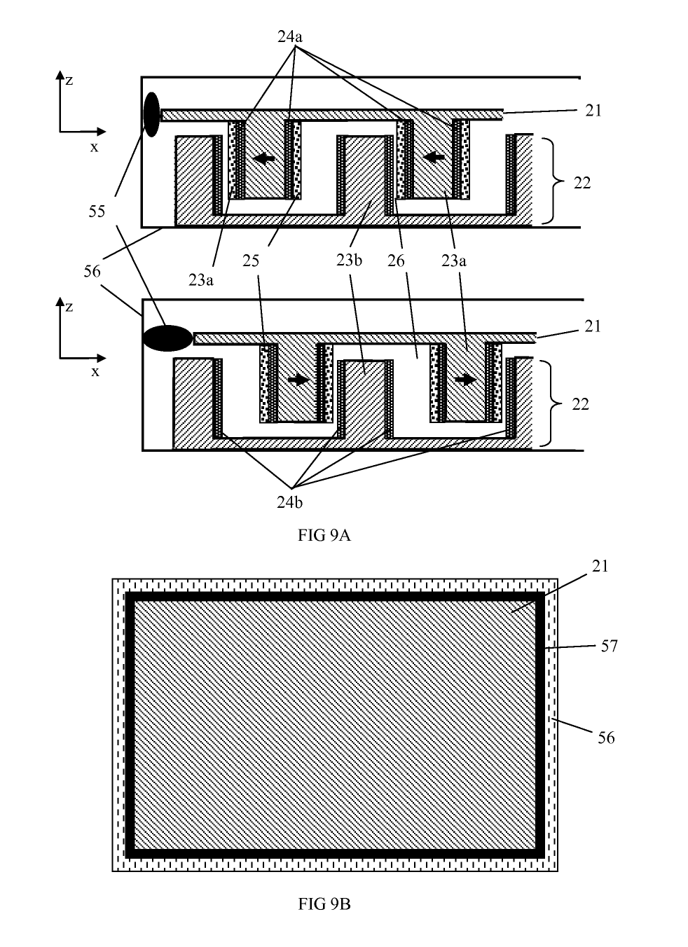

FIG. 9A shows a fourth embodiment of this invention in which elastic spacers 55 are used to return the first substrate 21 to equilibrium position relative to the second substrate 22. Electrostatic forces created by the time-varying potential difference are used still to cause the initial motion, but the return force is provided by the elastic spacer 55 so as to result in the oscillatory lateral movement. The elastic spacers 55 are positioned between the moving substrate 21 and the supporting frame 56. The reader will be aware that this is not the only position at which elastic spacers 55 can be placed to cause the return force. In an alternative arrangement to this embodiment, shown in FIG. 9B, an elastic seal 57 is placed around the edge of the first substrate 21. The elastic seal 57 functions like the elastic spacers 55 in serving to return the first substrate to an equilibrium position relative to the second substrate following lateral motion due to the electrostatic force created by the time-varying potential difference across the first and second electrodes. The elastic seal 57 includes the additional advantage that the system can then be sealed against the supporting frame 56 to prevent dirt and impurities entering the unit. The reader will be aware that a sealing mechanism can alternatively be used without it being responsible for the return force for the tactile motion.

In a fifth embodiment of this invention, there is no dielectric spacer between the electrodes. When the electrodes touch due to the electrostatic forces having driven them together, the charges held on the electrodes suddenly discharge causing an instantaneous increase in current between the electrodes. This sudden increase in current can be used as a signal to control the attached power supplies and change the voltages of the electrode sets such as to reverse the direction of the force. A significant disadvantage of this arrangement, however, is that the sudden discharge may damage the device due to irreversible electrical breakdown of the circuit and electrode structure.

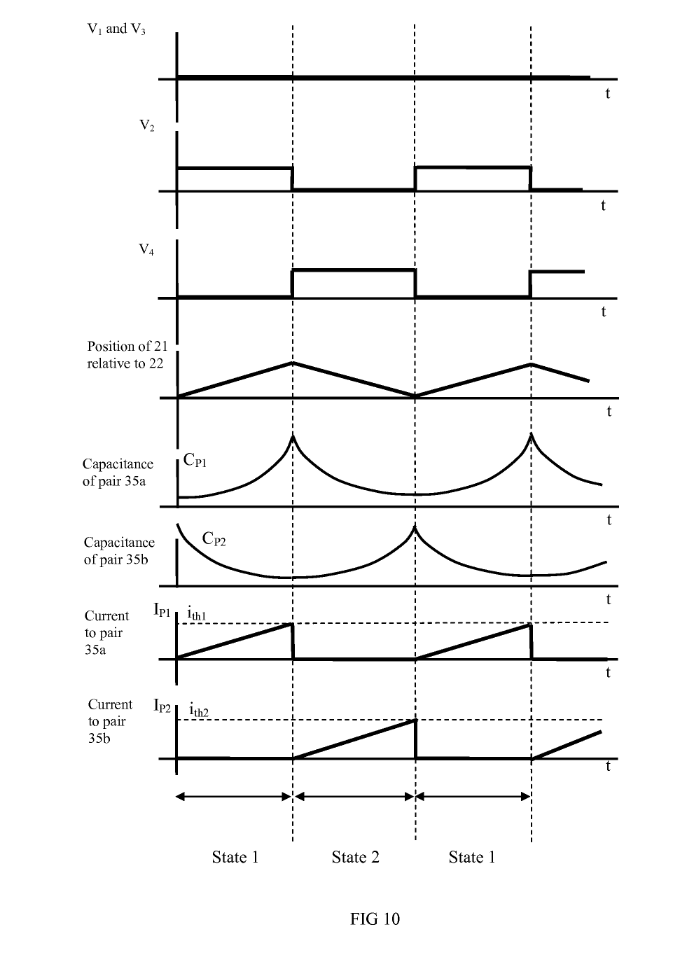

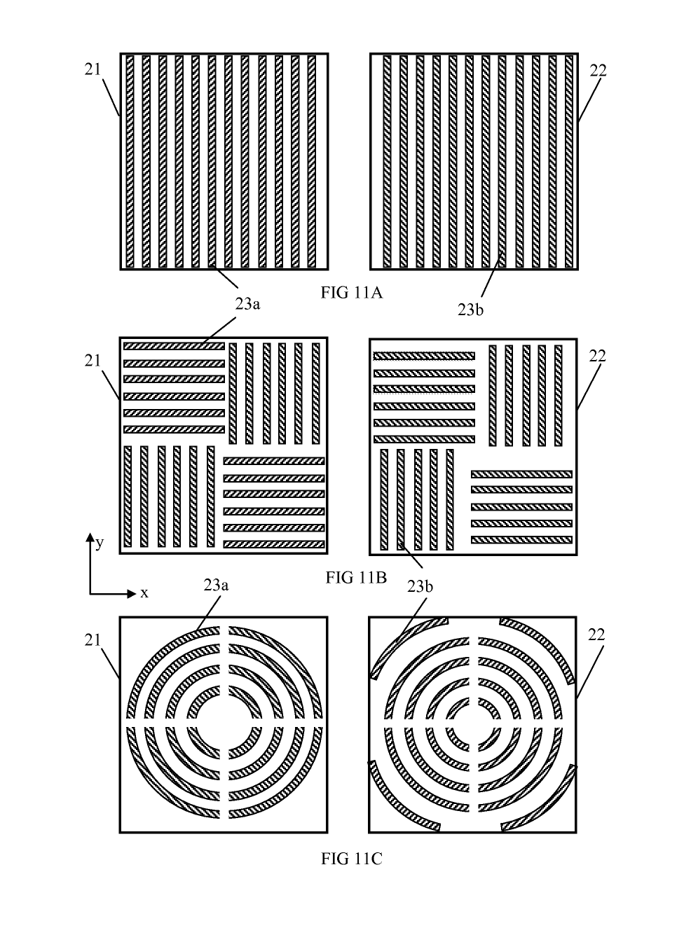

In an sixth embodiment, the changes in current drawn from the power supply due to the relative motion of the electrodes sets are used to control the waveforms applied to the electrodes. The principle of operation of this embodiment is illustrated in FIG. 10. In a first state of operation, State 1, voltage waveforms are applied to the electrode sets as indicated wherein V₁, V₃, and V₄ are at ground potential and V₂ has a different (positive shown) potential. Application of these voltage waveforms, which create a potential difference between electrode sets 41 and 42, generates an electrostatic force of attraction between the electrode sets 41 and 42 of the first pair 35a. The consequent motion of the first substrate 21 relative to the second substrate 22 reduces the distance between electrode sets 41 and 42 and the capacitance of the capacitor, C_{P1}, formed by the electrode pair 35a therefore increases. Provided that the electrode sets are held at a constant voltage, the charge held on the electrodes increases and must be supplied from the attached power supplies 45 thus generating a current, I_{P1}, which flows to the capacitor C_{P1}. This current may then be monitored to control the operation of the device. For example when a certain threshold current, iₜₕ₁, is exceeded due to the electrodes reaching a fixed minimum distance apart, the applied voltage waveforms changed from State 1 to State 2. In this State 2, V₁, V₂ and V₃ are driven to ground potential and a potential pulse (positive shown) is applied to V₄. The resultant potential difference between electrode sets 43 and 44 generates an electrostatic force of attraction between electrode sets 43 and 44 of the second pair. This results in an increase in the distance between the electrode sets 41 and 42 and a decrease in the distance between the electrode sets 43 and 44. The capacitance of the capacitor, C_{P2}, formed by the second electrode pair 35b therefore rises and generates a current, I_{P2}, flowing from the power supply to the capacitor. As before, the current increases up to a threshold value, iₜₕ₂, at which point the voltage waveform returns to their State 1 conditions. The threshold currents, iₜₕ₁ and iₜₕ₂, are set to occur below the point at which breakdown may occur. Dielectric layers 25 may also be present to prevent accidental electrical breakdown. Repeating the above operation causes the first substrate 21 to vibrate, relative to the second substrate 22, providing tactile sensations that can be detected by the user 01. Again, the reader will be aware of the symmetry in the system. This driving method may be applied to any of the arrangements disclosed in the first to sixth embodiments and incorporated in corresponding circuitry of the tactile feedback actuator controller described herein. Compared with the previous embodiment, this has the advantage that there is no danger of irreversible damage to the device occurring due to electrical breakdown.

In a seventh embodiment of this invention, the drive voltages are not restricted to being square waves or pulses, but can be of any appropriate waveform, for example saw-tooth, or sinusoidal. This may be advantageous in producing a wider variety of tactile effects i.e. allow the reproduction of a greater range of touch sensations to the user.

The condition that the ridges are straight, parallel lines is not necessary and may be restrictive, although it may provide the strongest forces for lateral motion within a parallel plate design. In an eighth embodiment of this invention, different ridge/electrode designs will allow lateral motion in more than one direction. FIG. 11A, FIG. 11B and FIG. 11C show variations of the ridge and thus electrode design pattern. FIG. 11A shows the original embodiment. FIG. 11B shows an embodiment in which ridges 23a, 23b face different directions over different regions of the corresponding substrates. Again, electrodes are formed on respective ridge walls. Whilst the design shown generates a maximum of only half the force of that generated in the original arrangement, it does allow motion in orthogonal lateral directions (i.e., the x and y directions). Further, with application of suitable voltage waveforms to the electrode sets, simultaneous motion in two directions can be generated to construct, for example, circular motion or diagonal motion in the lateral plane. Similarly, in FIG. 11C, circular separated electrodes may be employed to cause a similar effect. The reader will be aware that other electrode patterns are possible whilst remaining within the scope of the invention i.e. relative lateral motion of the surfaces.

In a ninth embodiment of this invention, the ridges 23a, 23b do not have a rectangular cross-section but instead may be triangular, hemispherical, semi-oval, trapezoidal, etc. Using the arrangements disclosed in the proceeding embodiments, structures such as there are capable of generating normal (z-axis) motion as well as lateral motion and may therefore be used to create complex tactile sensations requiring full three-dimensional motion of the device surface.

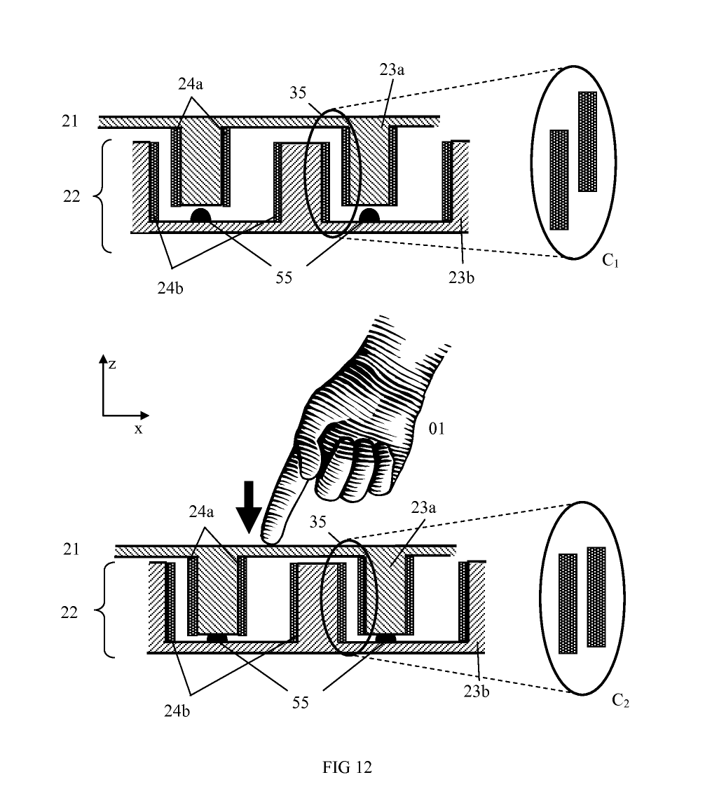

In a tenth embodiment of this invention, the normal component of the force applied by a finger on the surface can be detected by the change in the capacitance of a capacitor formed by a pair of electrode sets. The user's finger will move the first substrate relative to the second and this will alter its capacitance as illustrated in FIG. 12. Here, an example capacitance is shown between an electrode pair 35. In its unperturbed state, the capacitance of this pair, C_{P}, is equal to a first capacitance C₁. When the user applies a force to the surface, the area of the capacitor effectively increases thus increasing the capacitance of the pair to a second capacitance C₂, where C₂>C₁. The increase in capacitance can be related to the force applied. Elastic spacers 55 are added to provide a restoring force against that provided by the user.

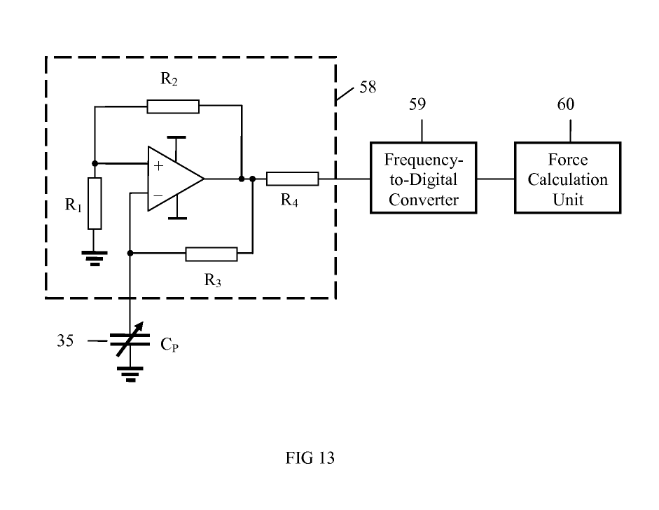

FIG. 13 shows a schematic diagram of a capacitance measuring system used in the tenth embodiment. The capacitance measuring system may be incorporated into the tactile feedback actuator controller described herein and includes: a capacitance to frequency conversion circuit 58; a frequency to digital conversion circuit 59 and a force calculation unit 60. The capacitance to frequency conversion circuit 58 may be of a well-known construction, for example, further comprising an operational amplifier and four resistors, R₁, R₂, R₃ and R₄. In operation, the capacitance measuring circuit 58 generates an output signal which is a square wave of frequency proportional to the capacitance to be measured—in this case the capacitance of the pair, C_{P}. The frequency to digital conversion circuit 59 generates a digital output signal which is a measure of this frequency and hence of the capacitance C_{P}. The force calculation unit 60 is used to convert the digital frequency signal to an absolute value of force corresponding to the force applied by the user 01 to the surface of the device. The force information may then be simply displayed back to the user or used as an additional input parameter for the touch-screen device. In an embodiment, the force information may be used in conjunction with or in place of a conventional touch panel to ascertain a location of a user's touch on the touch-screen device. The capacitance measuring system described above is intended as an example only; there are many well-known capacitance measuring circuits which may be used in its place.

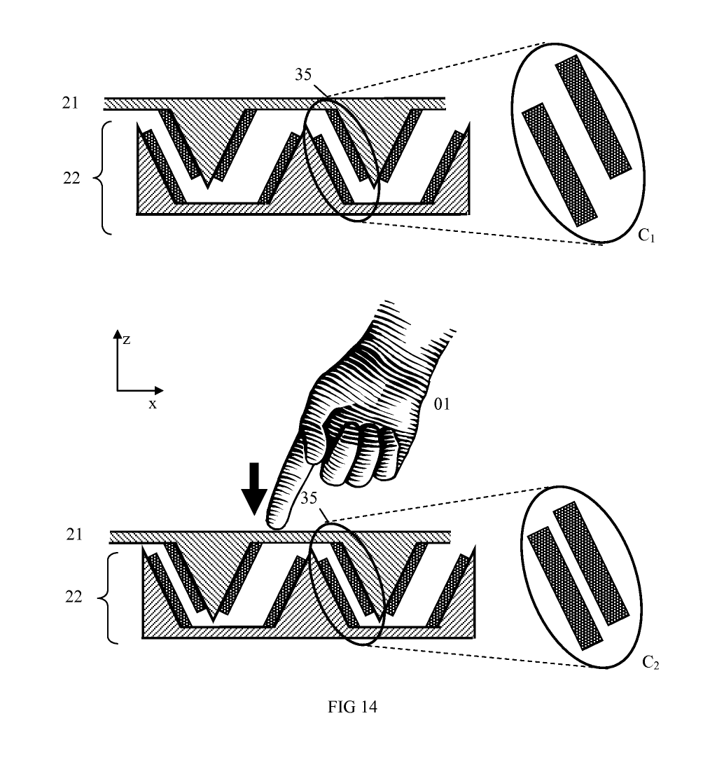

FIG. 14 shows the eleventh embodiment of this invention in which ridges of triangular cross-section—as described previously in the ninth embodiment—are used to detect force. An advantage of this arrangement is that it is possible to simultaneously create lateral and normal (z-axis) motion and detect lateral and normal applied force.

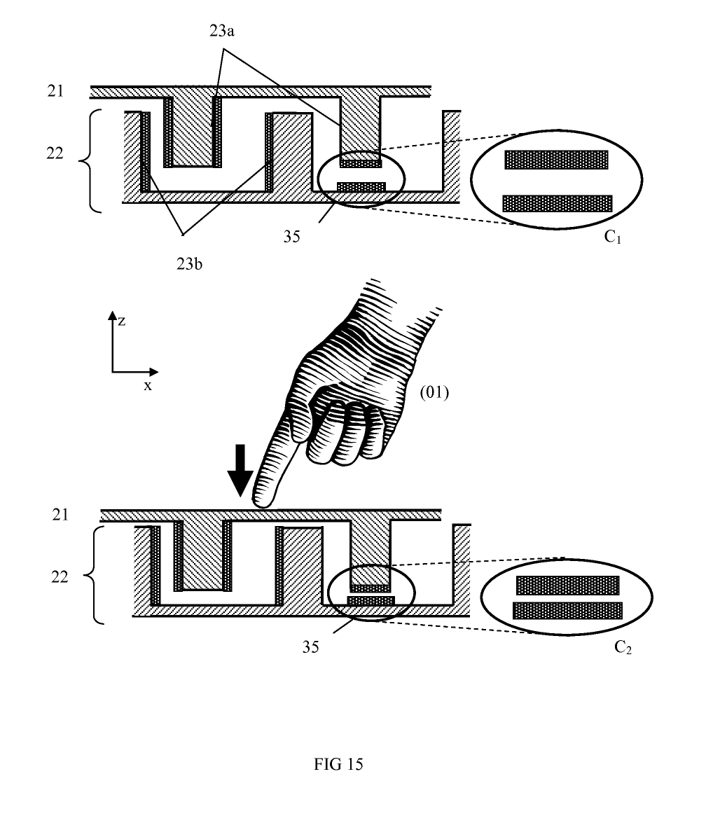

In a twelfth embodiment, some of the ridges, 23a and 23b, have electrodes coated on their peaks. These, independent to the actuating electrodes, measure the capacitance as a function of force as described in the twelfth and thirteenth embodiments. This arrangement is shown in FIG. 15 with respect to one of the ridges 23a. An advantage of this arrangement is that it is possible to simultaneously create lateral and normal (z-axis) motion.

In a thirteenth embodiment of this invention, the air-gap 26 (FIG. 4A) is filled with a low viscosity index matching fluid. This fluid is chosen to have the same refractive index as the ridges 23a, 23b and therefore reduces optical scattering caused by refraction occurring at the interfaces of surfaces of different refractive index.

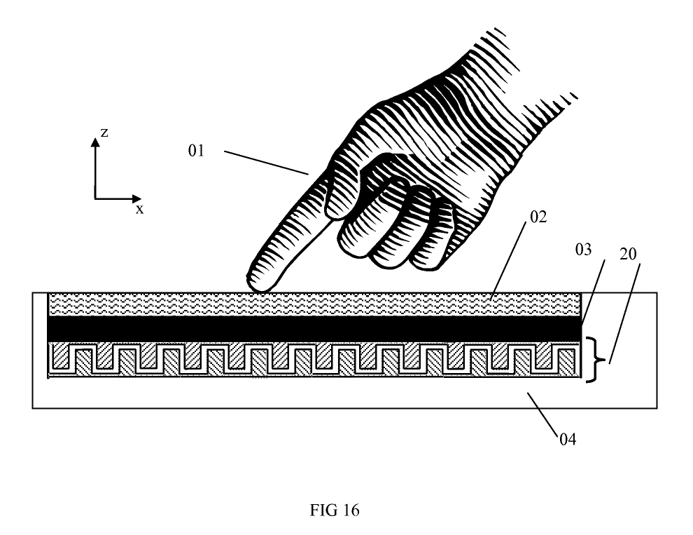

In a fourteenth embodiment of this invention, shown in FIG. 16, the tactile feedback actuator 20 is positioned below the display 03. The operation of the device is as discussed in the embodiments above but now the display 03 itself is included in what is laterally moved. An advantage of this embodiment is that the electrodes, index matching fluid, ridges and support material may be constructed fully or at least in part from non-transparent material.

In a fifteenth embodiment of this invention, the first substrate 21 is physically divided into small sections, each with its own, independently addressed set of electrodes. As such, individual areas of the surface of the first substrate can be vibrated independently to the rest. In this way, a multi-touch tactile feedback device may be realized.

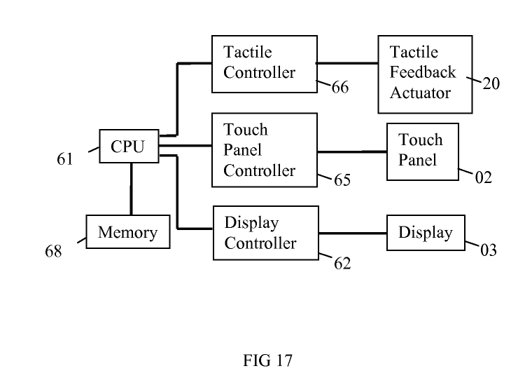

FIG. 17 shows a system block diagram of a touch-screen device with tactile feedback device as disclosed any of the above embodiments of this invention. The system comprises: a display controller 62 to generate an output image on the display 03; a touch panel controller 65 to process input signals detected by touch panel 02 in order to detect the location of a user's touch; a tactile controller unit 66 programmed using conventional techniques to activate the tactile feedback actuator 20 to generate tactile feedback sensations by providing the various driving voltages to the tactile feedback actuator electrodes in accordance with any of the embodiments described herein; a processing unit (e.g., CPU) 61 programmed using conventional programming techniques to co-ordinate the operation of the display 03, touch panel 02 and tactile feedback actuator 20; and a memory unit 68 to store images for display and waveform patterns for generating tactile sensations.

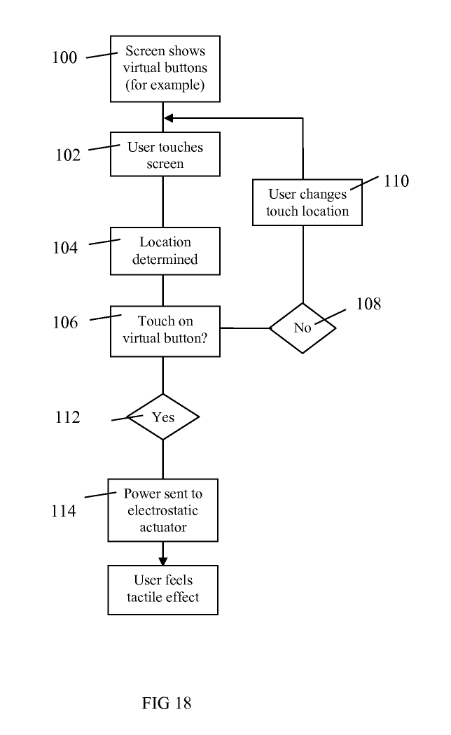

FIG. 18 shows a flow chart illustrating the operation the present invention. In step 100, the touch-screen device displays virtual buttons or the like on the display 03. When a user 01 touches the touch-screen device in step 102, the touch panel 02 and touch panel controller 65 determine the location of the touch on the touch-screen device using conventional techniques as represented in step 104. In step 106, the processing unit 61 determines whether the user 01 has touched a virtual button or other object associate with tactile sensations. When the user 01 presses the touch-screen device in a region of the display 03 not highlighted by an object associated with tactile sensations (for example a virtual button or scroll-bar) the tactile feedback actuator 20 is inactive and no tactile sensations are generated unless the user changes touch location (steps 108 and 110). However, when the user 01 touches a region containing an object associated with tactile sensations as represented in step 112, the processing unit 61 signals the tactile controller 66 to activate the tactile feedback actuator 20 to provide lateral motion of the surface of the device as described herein (step 114). These motions are then perceived by the user. Depending on the object, for example button, scrollbar, key or the like, a different tactile sensation may be generated based on the waveform patterns provided to the tactile feedback actuator 20. By appropriate control over the waveform applied to the tactile actuator, a virtual touch sensation close to that of a physical object may be re-created. For example, when a user presses virtual button on the touch-screen the feeling of touching a physical keyboard can be re-created. As a result, user satisfaction is increased and data entry error rates are reduced.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The present invention is ideally suited for products in which mono-touch tactile effects are required such as mobile phones, PDAs, e-readers, navigational devices etc. Such a device allows the surface to be vibrated in such a way as to make the user aware without direct visual observation, that an action has been performed. In this way, the safety issues of in-car-navigation devices are reduced and touch-screens can be produced which are able to be used by the visually impaired.

1. A touch-screen device, comprising:
a display;
a tactile feedback actuator arranged on the display, comprising:
a first substrate;
a second substrate facing the first substrate, the first substrate and the second substrate being parallel to each other in a lateral direction, and movable relative to each other in the lateral direction; and
an electrode arrangement on the first substrate and the second substrate, whereby a potential difference applied across two or more electrodes in the electrode arrangement produces an electrostatic force in the lateral direction between the first substrate and the second substrate; and
a controller configured to apply a time-varying potential difference across the two or more electrodes such that the resultant electrostatic force varies in the lateral direction and induces oscillatory lateral movement of the first substrate relative to the second substrate.

2. The touch-screen device according to any one of claim 1, wherein the oscillatory lateral movement is within a frequency range of 0 to 30 kHz.

3. The touch-screen device according to claim 2, wherein the oscillatory lateral movement is within a frequency range of 200 Hz to 300 Hz.

4. The touch-screen device according to claim 1, further comprising one or more elastic spacers for returning the first substrate to an equilibrium position relative to the second substrate following lateral motion due to the electrostatic force created by the time-varying potential difference so as to result in the oscillatory lateral movement.

5. The touch-screen device according to claim 1, further comprising an elastic seal for returning the first substrate to an equilibrium position relative to the second substrate following lateral motion due to the electrostatic force created by the time-varying potential difference so as to result in the oscillatory lateral movement.

6. The touch-screen device according to claim 1, wherein the controller applies the time-varying potential difference using driving voltages which are any one or more of a square wave, pulse, saw-tooth or sinusoidal waveform.

7. The touch-screen device according to claim 1, wherein the tactile feedback actuator is positioned above the display, and the first and second substrates and electrode arrangement are constructed of transparent material.

8. The touch-screen device according to claim 1, wherein the tactile feedback actuator is positioned below the display, and the first and second substrates are constructed at least in part of non-transparent material.

9. The touch screen device according to claim 1, wherein:
the first substrate includes a plurality of first ridges formed on a bottom of the first substrate;
the second substrate includes a plurality of second ridges formed on a top of the second substrate, the second ridges being interdigitated with the first ridges; and
the electrode arrangement includes one or more first electrodes on respective side walls of the first ridges, and one or more second electrodes on respective side walls of the second ridges.

10. The touch-screen device according to claim 9, wherein a gap is provided between adjacent first and second ridges to allow oscillatory lateral movement between the first and second substrates to an extent detectable by touch.

11. The touch-screen device according to claim 9, wherein the first electrodes are combined into a plurality of first electrode sets, the second electrodes are combined into a plurality of second electrode sets, the first and second electrode sets are arranged into pairs wherein each pair includes a corresponding one of the plurality of first electrode sets and one of the plurality of second electrode sets, and the controller is configured to generate movement in one lateral direction by providing driving voltages to each of the first and second electrode sets.

12. The touch-screen device according to claim 11, wherein the controller generates oscillatory lateral motion by alternately providing driving voltages to a first pair to generate movement in a first lateral direction and to a second pair to generate movement in second lateral direction opposite to the first lateral direction.

13. The touch-screen device according to claim 11, wherein the driving voltage applied to the first electrode set of a pair is of equal magnitude but opposite sign to the driving voltage applied to the second electrode set of the pair so that a potential difference is generated between the first and second electrode sets forming the pair to generate movement in a lateral direction.

14. The touch-screen device according to claim 11 wherein the controller maintains the potential of one electrode set of a pair at a constant value and applies a voltage pulse to the other electrode set of the pair so that a potential difference is generated between the electrode sets forming the pair to generate movement in a lateral direction.

15. The touch-screen device according to claim 11, wherein the controller comprises a voltage power supply and a plurality of switches for providing the driving voltages to the first and second electrode sets.

16. The touch-screen device according to claim 9, further comprising a dielectric spacer between electrodes on the side walls of adjacent interdigitated first and second ridges.

17. The touch-screen device according to claim 9, wherein electrodes on the sidewalls of adjacent interdigitated first and second ridges are capable of contacting one another.

18. The touch-screen device according to claim 9, wherein the controller monitors current provided to the first and second electrodes and varies the potential difference based on the current.

19. The touch-screen device according to claim 9, wherein the first ridges face different directions over different regions of the bottom of the first substrate and the second ridges face correspondingly different directions over different regions of the top of the second substrate.

20. The touch-screen device according to claim 9, wherein the first and second ridges are arranged to allow motion in orthogonal lateral directions.

21. The touch-screen device according to claim 9, wherein the first and second ridges are arranged in circular patterns.

22. The touch-screen device according to claim 9, wherein the first and second ridges have cross-sections which are at least one of rectangular, triangular, hemispherical, semi-oval or trapezoidal.

23. The touch-screen device according to claim 9, wherein the controller is configured to detect a normal component of a force applied to a surface of the tactile feedback actuator by touch of a user.

24. The touch-screen device according to claim 23, wherein the controller includes a capacitance measuring system for measuring a capacitance between adjacent first and second electrodes in order to detect the normal component of the applied force.

25. The touch-screen device according to claim 24, wherein the first and second ridges have triangular cross-sections.

26. The touch-screen device according to claim 9, wherein at least some of the first ridges and/or second ridges include electrodes on their peaks which oppose other electrodes on the opposite substrate, and the controller comprises circuitry to measure a capacitance between the peak electrodes and the opposing other electrodes.

27. The touch-screen device according to claim 9, wherein a fluid-filled gap is provided between adjacent first and second ridges.

28. The touch-screen device according to claim 27, wherein the fluid in the fluid-filled gap is an index matching fluid.

29. The touch-screen device according to claim 9, wherein the first substrate is physically divided into small sections, each with its own, independently addressed set of first electrodes.
